(19) United States
(12) Patent Application Publication
(10) Pub. No.: US 2006/0045704 A1
(43) Pub. Date: Mar. 2, 2006

(54) Hoist attachable to the receiver hitch of an automotive vehicle

(76) Inventors: Tony Laufenberg, Mount Horeb, WI (US); Arlan Smith, McCall, ID (US)

Correspondence Address: THE INVENTORS NETWORK, INC., 332 ACADEMY STREET, CARNEGIE, PA, 15106, US

(21) Appl. No.: 10/913,961

(22) Filed: Aug. 9, 2004

(51) Int. Cl. B60P 1/00

(52) U.S. Cl. 414/543

(57) ABSTRACT

A hoist for attachment to the rear of a sport utility vehicle or pickup truck includes an elbow member having a laterally projecting tow tube portion insertable on the receiver hitch of the vehicle, a base member adjustably securable to the lower end of the elbow member for contacting the ground and supporting the hoist, and a main post receivable on the upper end of the elbow member for rotatable movement thereon. The main post supports a winch assembly and a boom that laterally projects from the upper end of the main post for supporting a cable that raises, positions and lowers the load, and the interaction between a swivel plate at the upper end of the elbow member and a pivot ball at the lower end of the main post allows for the rotation of the main post on the elbow member.

### FIELD OF THE INVENTION

The present invention pertains to hoisting assemblies, and more particularly pertains to a hoist that is easily assembled for attachment to the rear of a vehicle for hoisting items and easily disassembled for storage, transport or use to different job sites.

### BACKGROUND OF THE INVENTION

Various types of trucks are used for transporting heavy loads and objects from one location to another such as from a job site to a dump or storage site, from one residence to another as part of the moving process or from a store to a residence as, for example, when a home appliance such as a refrigerator, washer or dryer is purchased. In addition to using commercial transport trucks, pickup trucks and sport utility vehicles are now commonly used to transport items and objects. These vehicles include a box-type drawbar or receiver hitch centrally located at the rear of the vehicle for the attachment of a trailer or bed on or in which the loads are transported. In addition, these vehicles can include a boom or hoist assembly for raising, lifting, moving and positioning such loads and items, and which can be mounted to the receiver hitch, one of the vehicle sidewalls, or to the upper edges of the vehicle bed sidewalls. Thus, because of the popularity of pickup trucks, SUVs, and sport trucks, the prior art discloses a range of hoist assemblies that are attachable to the rear of these vehicles for numerous hoisting and moving operations.

For example, the Hawkins patent (U.S. Pat. No. 4,069,922) discloses a portable crane wherein the hoist and boom are mounted on the bed of the pickup truck and a vertical support member is disposed outboard for supporting the hoist and boom.

The Harlan patent (U.S. Pat. No. 4,556,358) discloses a portable hoist attachable to the inside sidewall of a pickup truck, and includes a hydraulic powered unit for raising and lowering items.

The DeLuca et al. patent (U.S. Pat. No. 4,710,090) discloses a hydraulic hoist for placement on the bed of a pickup truck and which includes a chain and eye arrangement for minimizing the leverage effect on the column and boom during loading and unloading.

The Amato patent (U.S. Pat. No. 4,881,864) discloses a boom hoist that is attachable to the hitch of a vehicle and includes a swingable boom-type hoist for raising and lowering items on and off the bed of the pickup truck.

The Sunderland patent (U.S. Pat. No. 4,930,970) discloses a hoist for a truck bed that includes uprights that are assembled and rise above the sidewalls of the truck and a longitudinal beam having a hook and cable on its distal end for raising and lowering items.

The Buhr patent (U.S. Pat. No. 5,028,198) discloses a collapsible hoist for a truck bed and includes tracks mountable to the opposed sidewalls of the truck that support a u-shaped hoist frame and on which a trolley is mounted and from which a hook depends for lifting and moving items.

The Mills, Jr. patent (U.S. Pat. No. 5,281,078) discloses a portable hoist that includes an elongated base frame mounted to the ball hitch on the truck bed and a boom pivotally mounted thereto and extending rearward for raising and lowering heavy objects.

The Carey et al. patent (U.S. Pat. No. 5,752,799) discloses an apparatus for loading jet skis and wave runner onto the sidewalls of the pickup truck, and includes a lifting apparatus for lifting the watercraft on and off rails secured to the truck bed sidewalls.

The O'Meara patent (U.S. Pat. No. 6,095,349) discloses a knockdown hoist that includes a boom secured to a vertical member with the vertical member attached to a hitch member that is securable to the hitch pipe of a vehicle.

The Myers, Jr. patent (U.S. Pat. No. 6,138,991) discloses a hoist assembly securable to the rear of an ATV vehicle.

The Heyworth patent (U.S. Pat. No. 6,089,431) discloses a hoist apparatus for lifting large game animals, and includes a base mounted to the hitch receiver of a vehicle, a support column mounted to the base and a boom extending horizontally from the support column.

Nevertheless, despite the ingenuity of the above devices, there remains a need for a portable hoist for lifting heavy loads that can be easily assembled and disassembled by a single individual for operation, movement and storage.

### SUMMARY OF THE INVENTION

The present invention comprehends a hoist that is removably attachable to the rear of an automotive vehicle, such a pickup truck or sport utility vehicle, and specifically to the receiver hitch or triangular drawbar of the vehicle for raising and lifting heavy objects and loads onto the storage compartment or bed of the vehicle and for removing and lowering loads from the rear storage compartment or bed of the vehicle to the ground.

The hoist of the present invention includes a main support post or stanchion that has a boom laterally extending from the upper end of the main support post. The lower end of the main support post is received into the upper end of an elbow member. The elbow member also includes a tow tube portion that laterally projects from the elbow member and which is removably attachable to the drawbar or receiver hitch at the rear of the vehicle. The elbow member includes a lower end that telescopically receives therein a base member so that the base member can be appropriately adjusted and then secured to in position to the lower end of the elbow member for contacting the ground and supporting the vertical extension of the main support post. Mounted to the main support post and the boom is a winch assembly that includes a main pulley on which a cable is wound and a manually operable hand crank for winding and unwinding the cable so that the load can be raised or lowered. A cable pulley is mounted to the distal end of the boom, and the end of the cable has a hook attached to it for hooking onto loads so that the loads can be raised and lowered. A swivel mechanism that engages the lower end of the main support post and the upper end of the elbow allows the main support post—and the boom—to rotate on the elbow member for reaching loads that are located adjacent the rear of the vehicle.

It is an objective of the present invention to provide a hoist that allows the individual to reliably lift and lower heavy objects and loads into the storage compartment or bed of the automotive vehicle.

It is another objective of the present invention to provide a hoist that can be quickly assembled for use and disassembled for transport and storage by one individual.

It is yet another objective of the present invention to provide a hoist that can be used in residential, commercial and farm applications.

It is a still further objective of the present invention to provide a hoist that allows the individual to lift heavy loads with the minimum of physical exertion by the individual.

A still further objective of the present invention is to provide a hoist that can remain attached to the receiver hitch of the vehicle while the vehicle is being moved forward or backward for positioning to better align the hoist for the raising or lowering of loads.

These and other objects, features and advantages will become apparent to one skilled in the art upon a perusal of the following detailed description read in conjunction with the accompanying drawing figures.

### BRIEF DESCRIPTION OF THE DRAWINGS

FIG. 1 is a perspective view of the hoist of the present invention illustrating the disposition of the hoist after the hoist has been assembled for use and attached to the receiver hitch of the vehicle;

FIG. 2 is a side elevational view of the hoist illustrating the attachment of the hoist to the rear of a pickup truck so that the hoist can lift and lower items and loads into and out of the bed of the pickup truck;

FIG. 3 is a side elevational view of the hoist illustrating the attachment of the hoist to the rear of a sport utility vehicle so that the hoist can lift and lower items and loads through the top opening rear door for placement into or removal from the rear storage compartment of the sport utility vehicle;

FIG. 4 is a top plan view of the hoist illustrating the range of rotatable motion of the hoist when attached to the receiver hitch of the pickup truck;

FIG. 5 is a perspective view of the hoist illustrating the securement of the main support post to the elbow member, the tow tube portion to the receiver hitch and the lower end of the elbow member to the base member;

FIG. 6 is a sectioned elevational view of the hoist illustrating the alignment of the lower end of the main support post with the upper end of the elbow member prior to interconnection; and

FIG. 7 is a sectioned elevational view of the hoist illustrating the interconnection of the lower end of the main support post to the upper end of the elbow member so that the swivel mechanism can allow the main support post to pivot on the elbow member.

### DETAILED DESCRIPTION OF THE PREFERRED EMBODIMENT

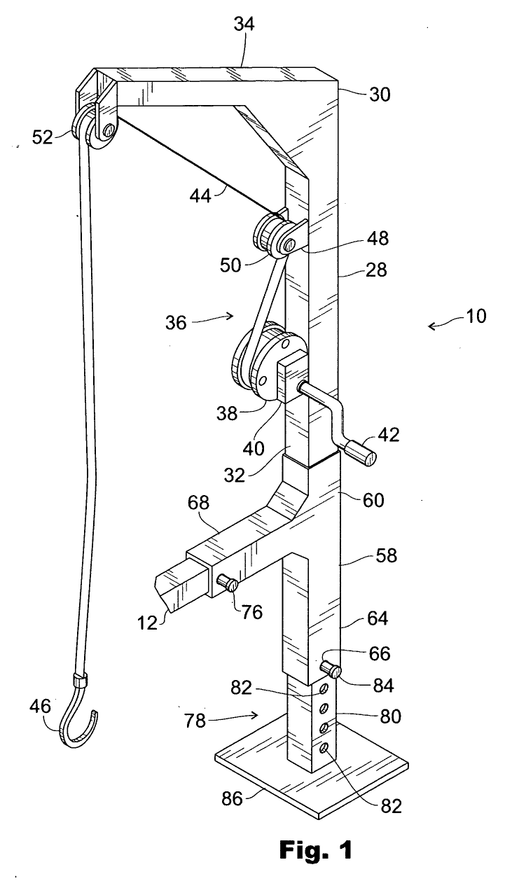

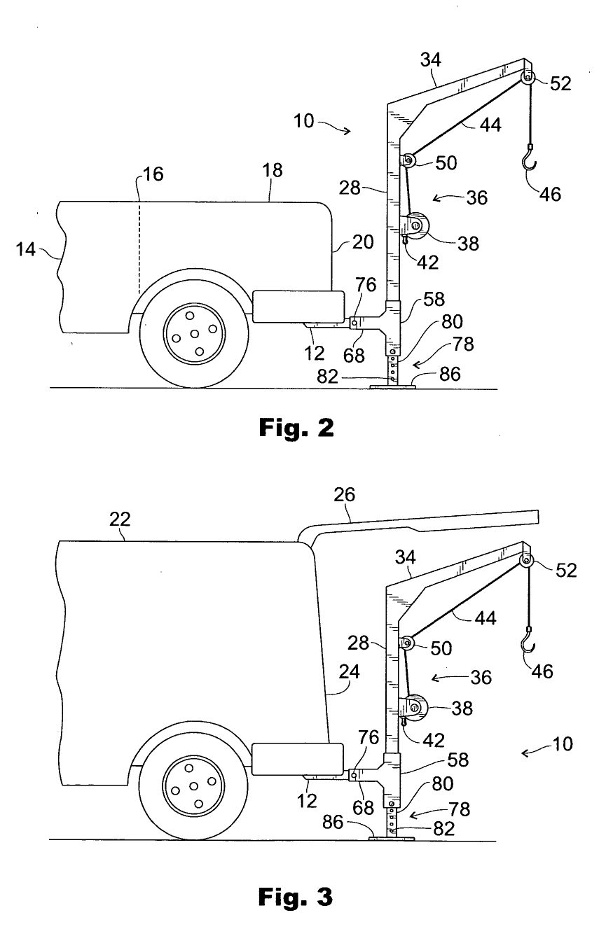

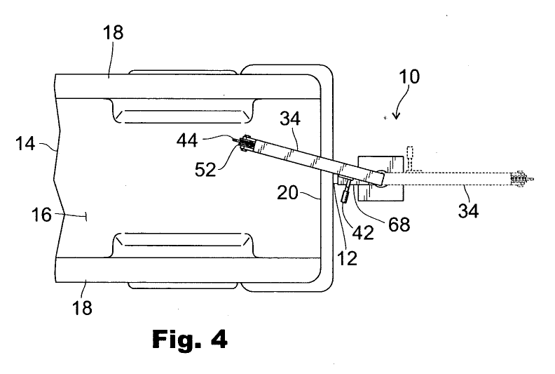

Illustrated in FIGS. 1-7 is a hoist mechanism or assembly that attaches to the rear of an automotive vehicle for lifting, moving, lowering and positioning items, objects and loads in and out of the vehicle, and which are too heavy and cumbersome for an individual to lift and move. The hoist 10 is specifically adapted for removable attachment to the box-type drawbar or receiver hitch 12 that laterally extends from the rear central portion of the automotive vehicle. The type of automotive vehicle for which the hoist 10 of the present invention is primarily adapted is a pickup truck 14, as shown in FIG. 2, having a rear storage bed 16 defined by opposed sidewalls 18 and closed off by a tailgate 20 or an SUV or sport utility vehicle 22, as shown in FIG. 3, having a rear storage compartment 24 that has a side, bottom or top opening door 26; nonetheless, hoist can be used with any vehicle that has a rearwardly extending, box-type trailer hitch or draw bar. A primary advantage of the hoist 10 of the present invention is that it can be easily assembled by one individual for securement to the receiver hitch of the vehicle, and it can be easily and quickly disassembled by one individual for break-down, storage or transport to another job site whereupon the hoist 10 can then be easily and quickly reassembled for use.

As shown in FIGS. 1-7, the hoist 10 includes a main support post, column or stanchion 28 that is oriented in a vertically upright position adjacent the rear of the vehicle 14 or 22 when assembled for use. The main support post 28 includes an upper end 30 and an opposite lower end 32. One preferable length for the main support post 28 is 66 inches, and such a length will allow the main support post 28 to easily surmount the bed 16 of the pickup truck 14 for lifting and lowering loads therein and removing loads from the bed 16. The main support post 28 is predominantly square-shaped from the upper end 30 downward, but the lower end 32 is circular-shaped to facilitate the attachment and the pivotal motion of the main support post 28 as will be explained hereinafter.

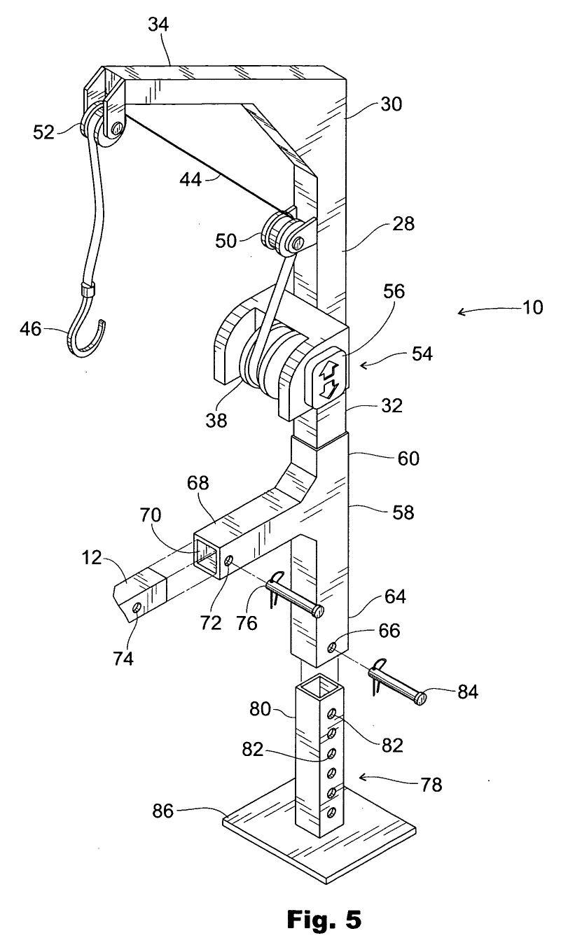

As shown in FIGS. 1-4, laterally extending at a slight angle from the upper end 30 of the main support post 28 is a boom 34. The boom 34 is preferably at least 18 inches long for spanning the distance from the point of attachment of the hoist 10 at the receiver hitch 12 across the tailgate 20 and to the bed 16 of the pickup truck 14 or into the storage compartment 24 of the sport utility vehicle 22. The main support post 28 and the boom 34 supports a winch assembly 36 that is easily operable by the individual for raising and lowering loads on and off the vehicles 14 and 22. The winch assembly 36 includes a main pulley 38 mounted to the main support post 28 by brackets 40. A manually rotatable crank 42 extends from the main pulley 38 and is turned clockwise or counterclockwise for unwinding or winding a cable 44 that is mounted on the main pulley 38 and that has a hook 46 attached at the end of the cable 44. The hook 46 is secured to the load for raising or lowering the load. The cable 44 is preferably ⅜-inch cable with a total length of approximately 25 feet. Secured to the main post 28 by brackets 48, and located above the main pulley 38, is an idler pulley 50 that takes up some of the slack of the cable 44 and assists in keeping the cable 44 taut when the cable 44 is being wound or unwound during the raising and lowering of loads. Mounted to the distal end of the boom 34 is a cable pulley 52 over which the cable 44 runs for attaining maximum leverage for lifting the load, as the cable pulley 52 generally will be positioned above the load during any lifting operation. Although the winch assembly 36 shown in FIGS. 1-4 is manually operable, FIG. 5 illustrates a winch assembly 54 that as an alternative is electric powered and thus would comprise a power winch and turning system and further includes a push button or slide switch 56 that actuates the winding and unwinding of the cable 44 for raising and lowering loads.

Illustrated in FIGS. 1-7 is an elbow member 58 that includes elements that provide for the removable securement of the elbow member 58 to the receiver hitch 12 and to the lower end 32 of the main support post 28. More specifically, the elbow member 58 includes an upper elbow end 60 that is cylindrical-shaped and defines a bore or passageway 62 for receiving the circular-shaped lower end 32 of the main support post 28. The elbow member 58 also includes a lower elbow end 64 that is hollow and square-shaped and includes a pair of opposed base locking apertures 66. Further, the elbow member 58 includes a tow tube portion 68 that laterally extends from the elbow member 58 approximately 23 inches. The tow tube portion 68 includes a receiver passageway 70 that slides onto and over the receiver hitch 12 for attaching the tow tube portion 68 to the receiver hitch 12. Located at the distal end of the tow tube portion 68 is a pair of opposed hitch apertures 72. The hitch apertures 72 are brought into alignment with apertures 74 located at the end of the receiver hitch 12 so that a locking pin or bolt 76 can be inserted through all the apertures 72 and 74 for locking the elbow member 60 to the receiver hitch 12.

As shown in FIGS. 1-5, the hoist 10 includes a main post supporting means that contacts the ground for reliably supporting the main post 28 thereon, and which is also slidably adjustable to accommodate the fact that receiver hitches for different types of vehicles may vary in their distance from the ground. Also, the slidable adjustment of the main post supporting means allows the individual to position and reposition the hoist 10 by moving, for example, the vehicle 14 or 22 forward or backward while maintaining the attachment of the hoist 10 to the receiver hitch 12 thereby saving time and labor by not having to disconnect and then reconnect the hoist 10 to the vehicle 14 or 22 each time the vehicle 14 or 22 may need to be moved. The main post supporting means includes a base member 78, and the base member 78 includes an upright member 80 that is square-shaped and approximately 15 inches long and further defined by pairs of opposed base apertures 82 that are equidistantly spaced along two opposed sides of the upright member 80. The upright member 80 is slidably telescopically adjustable within the lower end 64 of the elbow member 58 so that the appropriate extension of the base member 78 for contacting the ground can be obtained to thereby support the main post 28. After the appropriate position for the upright member 80 is found, the base member 78 is locked to the elbow member 58 by inserting a locking stud, pin or bolt 84 through the aligned base apertures 82 and the locking apertures 66 on the lower end 64 of the elbow member 58. To provide a solid and stable base for the main support post 28, the base member 78 includes footplate 86 at least five inches square that engages and is placed contiguous to the ground.

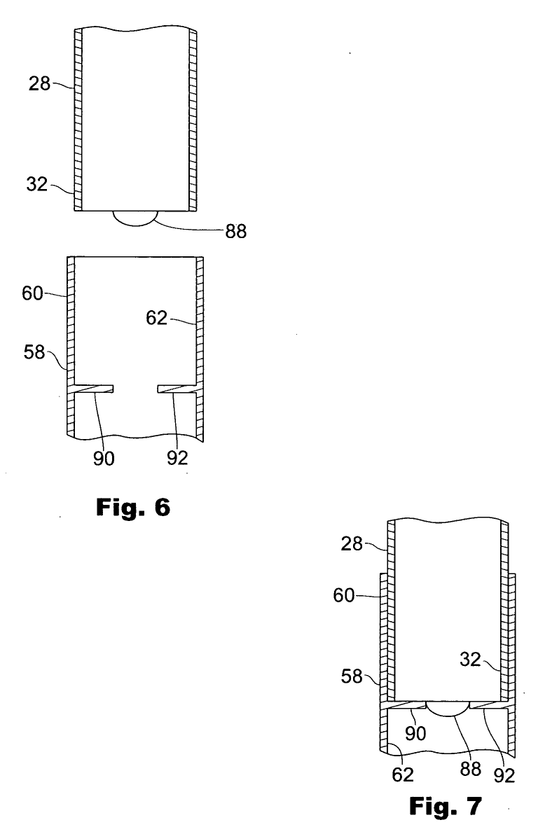

As illustrated in FIGS. 6 and 7, the hoist 10 includes a swivel mechanism or means that permit a 360-degree rotation of the main support post 28 and the boom 34 on the elbow member 58. The swivel means enhances the capability of the hoist 10 by allowing the individual to pivot or turn the main post 28 on the elbow member 58 to reach loads that are adjacent, but not directly underneath the main post 28 when the main post 28 is attached to the receiver hitch 12. The swivel means includes a pivot ball 88 mounted at the lower end 32 of the main support post 28 and a swivel plate 90 mounted within the passageway 62 of the upper end 60 of the elbow member 58. The swivel plate 90 includes a swivel plate aperture 92 for receiving therein the pivot ball 88. When the lower end 32 of the main support post 28 is slidably inserted within the upper end 60 of the elbow member 58 as part of the process of assembling the hoist 10, the swivel plate 90 provides a stop for the pivot ball 88 and also a surface against which the pivot ball 88 can rotate. The individual can turn the hoist 10 to the desired position by manually grasping and rotating either the main support post 28 or the boom 34 and this rotatable action is provided by the pivotal engagement of the pivot ball 88 with the aperture 92 of the swivel plate 90.

While a preferred embodiment of the invention has been shown and described, such description is for illustrative purposes only, and it is to be understood that numerous modifications, variations, and alterations may be made without departing from the spirit or scope of the following claims.

I claim:

1. A hoist for securement to the receiver hitch located at the rear of an automotive vehicle, comprising:
an elbow member having an upper end, an opposite lower end, and a tow tube portion that laterally projects from the elbow member for removable attachment to the receiver hitch;
a swivel plate disposed within the elbow member adjacent the upper end;
a base member insertable into the lower end of the elbow member for adjustable telescoping movement therein so that the base member can be brought into contact with the ground for supporting the hoist;
a main support column removably securable to the upper end of the elbow member and extending substantially vertically above the vehicle;
the main support column having an upper end and an opposite lower end and the lower end having a pivot ball mounted thereto;
a boom laterally extending from the upper end of the main support column;
a manually operable winch assembly mounted to the mains support column and the boom for winding and unwinding a cable that extends therealong for lifting loads on and off the vehicle; and
the pivot ball of the main support column capable of rotatable movement on the swivel plate so that the main support column and the boom can be rotated to hoist loads adjacent the rear of the vehicle.

2. The hoist of claim 1 wherein the winch assembly includes a main pulley mounted to the main support column.

3. The hoist of claim 2 wherein the winch assembly includes an idler pulley mounted to the main support column and above the main pulley.

4. The hoist of claim 3 wherein the winch assembly includes a cable pulley mounted to the distal end of the boom.

5. The hoist of claim 4 wherein the winch assembly includes a manually rotatable crank interconnected to the main pulley for winding and unwinding the cable to raise and lower loads on and off the vehicle.

6. The hoist of claim 5 further comprising a ring mounted to the main support column below the main pulley for holding and stabilizing the cable.

7. The hoist of claim 6 wherein the upper end of the elbow member is cylindrical to receive the lower end of the main support column thereby allowing the lower end of the main support column to rotate therein.

8. The hoist of claim 7 wherein the lower end of the elbow member is square-shaped for receiving the base member and allowing for the telescopic adjustment of the base member with respect to the lower end of the elbow member.

9. The hoist of claim 8 further comprising at least one locking pin insertable through the base member and the lower end of the elbow member for locking the elbow member to the base member and fixing the height of the main support column.

10. The hoist of claim 9 wherein the base member includes foot plate for contacting the ground and supporting the vertical disposition of the main support column and movable with the telescopic movement of the base member

11. The hoist of claim 10 wherein the winch assembly is electric-powered for winding and unwinding the cable.

12. The hoist of claim 11 wherein the main support column, the elbow member and the base member can be assembled and disassembled by a single individual for use, transport and storage.

13. A hoist removably securable to the receiver hitch of an automotive vehicle for raising and lowering loads on and off the storage bed of the vehicle, comprising:
a main support post disposed adjacent the rear of the automotive vehicle, the main support post having an upper post end and an opposite lower post end;
a boom attached to the upper post end and laterally extending therefrom;
a winch assembly mounted to the main support post and rotatably supporting thereon a cable that extends alongside the main support post and the boom and that can be wound and unwound for raising and lowering loads;
an elbow member having an upper elbow end for receiving the lower post end of the main support post and an opposite lower elbow end for disposition adjacent the ground;
a tow tube portion laterally extending from the elbow member and removably attachable to the receiver hitch of the vehicle;
a base member telescopically insertable into the lower elbow end of the elbow member for contacting the ground and supporting the vertical orientation of the main support post;
a pivot ball mounted to the lower post end of the main support post;
a swivel plate mounted within the upper elbow end of the elbow member; and
the pivot ball disposed upon the swivel plate for rotatable movement thereon so that the main support post and the boom can rotate 360 degrees for raising, moving and lowering loads on and off the storage bed of the vehicle.

14. The hoist of claim 13 wherein the winch assembly includes a main pulley mounted to the main support post.

15. The hoist of claim 14 wherein the winch assembly includes an idler pulley mounted to the main support post above the main pulley.

16. The hoist of claim 15 wherein the winch assembly includes a cable pulley mounted to the distal end of the boom.

17. The hoist of claim 16 wherein the winch assembly includes a manually operable hand crank interconnected to the main pulley for turning the main pulley to wind and unwind the cable so that the load can be raised and lowered.

18. The hoist of claim 17 further comprising a ring mounted to the main support post below the main pulley for holding and stabilizing the cable.

19. The hoist of claim 18 wherein the lower elbow end of the elbow member is square-shaped for telescopically receiving the base member.

20. The hoist of claim 19 wherein the upper elbow end of the elbow member is cylindrical-shaped for receiving the lower post end and allowing for the rotation of the lower post end within the upper elbow end of the elbow member.

21. The hoist of claim 20 further comprising at least one locking pin insertable through the base member and the lower elbow end for locking the base member to the elbow member and fixing the height of the main support post.

22. The hoist of claim 21 wherein the base member includes a footplate for contacting the ground and supporting the vertical extension of the main support post and being movable with the base member.

23. The hoist of claim 22 wherein the winch assembly is electric powered for winding and unwinding the cable.

24. The hoist of claim 23 wherein the main support post, the elbow member and the base member can be assembled and disassembled by one individual for use, transport and storage.

25. A hoist securable to the receiver hitch of an automotive vehicle for raising, positioning and lowering loads to and from the bed of the vehicle, comprising:
a main support post for disposition adjacent the bed of the vehicle, the main support post having an upper post end and an opposite lower post end;
a boom attached to the upper post end and laterally extending therefrom;
a winch assembly mounted to the main support post and rotatably supporting a cable that extends along the main support post and the boom and that can be wound and unwound for raising, positioning and lowering loads;
an elbow member having a cylindrical-shaped upper elbow end for receiving the lower post end of the main support post, and an opposite square-shaped lower elbow end for disposition adjacent the ground;
a tow tube portion laterally extending from the elbow member and removably securable to the receiver hitch;
a base member for telescopically adjustable securement to the lower elbow end of the elbow member for contacting the ground and supporting the vertical orientation of the main support post;
a ring mounted to the main support post below the winch assembly for supporting and stabilizing the cable when raising, positioning and lowering loads;
a pivot ball mounted to the lower post end of the main support post;
a swivel plate mounted within the upper elbow end of the elbow member; and
the pivot ball disposed on the swivel plate for rotatable motion thereon so that the mains support post and the boom can rotate 360 degrees for raising, positioning and lowering loads to and from the bed of the vehicle.

26. The hoist of claim 25 wherein the winch assembly is electric powered for raising, positioning and lowering loads to and from the bed of the vehicle.
